(19) United States
(12) Patent Application Publication
(10) Pub. No.: US 2015/0178467 A1
(43) Pub. Date: Jun. 25, 2015

(54) METHOD TO DETERMINE A PATIENT-SPECIFIC INJECTION PROFILE FOR ADMINISTERING A THERAPEUTIC SUBSTANCE

(71) Applicant: Siemens Aktiengesellschaft, Muenchen (DE)

(72) Inventors: Stefan Britzen, Buckenhof (DE); Thomas Redel, Poxdorf (DE)

(73) Assignee: SIEMENS AKTIENGESELLSCHAFT, Muenchen (DE)

(21) Appl. No.: 14/576,633

(22) Filed: Dec. 19, 2014

(30) Foreign Application Priority Data
Dec. 20, 2013 (DE) 102013226924.2

(51) Int. Cl. G06F 19/00; G06T 17/00

(52) U.S. Cl. CPC G06F 19/3437; G06T 17/00

(57) ABSTRACT

In a method to determine a patient-specific injection profile for injection of a therapeutic active substance into a vascular system of a patient, which can be implemented by an image analysis device a model of the current flow of a bodily fluid located in the vascular system is determined using a provided 3D image data set of a sub-region of the vascular system, by segmentation of the 3D image data. Inflows and outflows are determined, as well as an inflow curve of the fluid in the sub-region. A virtual two-dimensional representation of a contrast agent injected into the sub-region is determined. A provided 2D image data set, as a real two-dimensional depiction of the sub-region, is compared with the virtual representation and/or the model is adapted to individualize the model. The injection profile is determined by determination of at least one parameter of the planned injection using the individualized model.

### BACKGROUND OF THE INVENTION

1. Field of the Invention

The present invention concerns a method to determine a patient-specific injection profile that, for example, describes an injection flow, an injection point in time and/or an injection location, wherein the injection profile predetermines how an injection of a therapeutic substance into a vascular system of a patient should be implemented.

2. Description of the Prior Art

If possible, tumors are treated surgically, meaning that the locations that are afflicted by tumors are removed in an open operation. Unfortunately, not all tumors can be surgically resectioned, which has led to the development of alternative methods—for example ablation (cooking of the tumor tissue via a percutaneously introduced needle) or also chemo-perfusion (administration of the chemotherapy medication to the arterial supply line of the afflicted organ).

A method that is likewise often implemented is trans-arterial chemo-embolization (“TACE”), which is based on tumor-supplying (capillary) vessels being chemically sclerotized in order to thus stop the further growth of the tumor. TACE is, for example, a minimally invasive method for treatment of a liver tumor or, respectively, of liver metastases. This method is implemented in an angiography and combines the administration of multiple medicines with simultaneous embolization of arteries by means of small particles.

In this procedure, a catheter is introduced into the artery that supplies the liver and, after contrast agent injection, a two-dimensional (“2D”) digital subtraction angiography (“DSA”) is implemented using a C-arm system x-ray imaging. After appropriate planning, the catheter is then pushed forward into the main branch or sub-branch to be treated and the embolization is implemented. This therapy functions well since the tumor is supplied predominantly by arterial vessels, in contrast to the healthy liver tissue.

The vessels to be sclerotized are filled with a chemo-embolizate until chemo-embolizate no longer flows in the vessels, which frequently means closing off an important access for follow-up therapies. Moreover, a standardized representation of (for example) a blood vessel system of the liver never shows the actual anatomy of a vascular system of an individual patient who, due to individual anatomical form or due to a prior surgical treatment of the vascular system, has a divergently shaped vascular system.

It is also not always possible to inject only into the sub-branch supplying the tumor (for example due to the vessel diameter being too small). Other areas are thus affected as well, which must be accepted. However, the dose that is effective in the tumor is reduced by the amount that is lost to these other areas. In order to be able to implement precise plans regarding the quantity of embolizate that is to be applied, it is helpful to know the precise arterial tumor supply and that of the other side branches.

### SUMMARY OF THE INVENTION

An object of the invention is to reduce the healthy tissue proportion that is affected by an active substance during a treatment of a vascular system.

The basis of the invention is to optimize a three-dimensional model of the relevant vascular system of a patient, for example for a CFD simulation (Computational Fluid Dynamics Simulation) of a blood vessel using a two-dimensional image data set, for example a digital 2D subtraction angiogram, and to customize (individualize) its use in patients in order to be able to implement the treatment quantity with the model. For example, information can be obtained for an ideal therapy planning (for example for TACE). In addition, the approach offers the possibility to compare the planning results with the real conditions based on the model.

The method according to the invention serves to determine a patient-specific injection profile that predetermines how an injection of a therapeutic substance (for example the injection of a chemo-embolizate within the framework of a TACE) into a vascular system of a patient should be implemented. For example, the injection location, injection point in time and/or the amount of active substance injected per time unit is established via the injection profile. The implementation of the planned injection is thereby not encompassed by the claimed invention. The method includes the following steps implemented by an image analysis device.

A model of the current flow of a bodily fluid that is located in the vascular system (for example a blood flow simulation) is determined using a provided 3D image data set of a sub-region of the vascular system, by segmentation of the 3D image data, and at least one inflow and/or at least one outflow of the sub-region are determined, and an inflow curve of the fluid in the sub-region is then also determined.

A virtual two-dimensional presentation of the current flow of a contrast agent injected into the sub-region is determined, for example a two-dimensional information as a two-dimensional representation.

A provided 2D image data set (for example a 2D angiography data set), as a real two-dimensional representation of the sub-region, is compared with the virtual representation and/or the model is adapted in order to individualize the model.

The injection profile is determined by determining at least one parameter that concerns the implementation of the planned injection, using the individualized model.

The method according to the invention enables an optimization of a planned procedure before its implementation, without a parameter setting (for example the optimization of an amount of active substance to be injected) taking place at the patient in the course of the optimization process. One or more parameters of an injection to be implemented (i.e. of the injection profile) can be adapted to the vascular system specifically so that a treatment of the patient that is implemented later can be implemented more successfully than before. High stress experienced by the patient, due to a larger number of procedures or administration of amounts of active substance that are too large, is significantly reduced, or avoided. Additional damage to healthy regions of the vascular system is prevented nearly entirely. The method according to the invention furthermore enables the possibility of validating the three-dimensional depiction of the vascular system (for example a CFD simulation) with the use of the two-dimensional image data set and the virtual presentation of the model. A better therapy planning and estimation of success thus can be achieved. The method employed for a treated person additionally serves as a control method with which a planned procedure can be checked.

As used herein, the aforementioned representation can include an image data set and/or a mapping. An inflow curve of the fluid can be used to compare the provided 2D image data set with the virtual presentation. An inflow curve represents a mathematical function that describes a fluid amount flowing into a sub-region of the vascular system over a predetermined time period and, for example, describes a diastole or systole affecting the sub-region. An inflow (thus a vessel position) at the fluid flowing into the sub-region is determined and one or more corresponding outflows are thus personalized in the model. With the aid of a time/intensity curve, the time curve (for example an arrival of a particle of the fluid or a point in time of an outflowing particle, for example) of the virtual angiography can be compared with that of the real angiography.

In an embodiment of the method according to the invention, the determination of the at least one parameter that concerns the planned injection can include the determination of an injection point in time, of an amount of active substance and/or of an injection point in the sub-region as a parameter, in order to efficiently reduce the stressing of the body of the patient.

In a further embodiment of the method according to the invention, a method step to optimize the injection profile according to an optimization criterion—in particular via variation of the injection point in time—can additionally improve the injection profile, and therefore more successfully bring about the aforementioned advantages of the method according to the invention. For example, for this a particularly advantageous distribution of the active substance can be determined as an optimization criterion in that the personalized model is simulated with different injection points in time until (for example) a desired distribution speed or a specific transport of the active substance within the sub-region can be determined.

In a further embodiment of the method according to the invention, the determination of the virtual two-dimensional depiction of the current flow can take place via a) extraction of a time curve of the contrast agent injected into the sub-region from the provided 2D image data set, b) synchronization of the time curve with a patient-specific parameter and/or c) transfer of the time curve to the model of the current flow.

The determination of the virtual two-dimensional presentation by the use of a provided electrocardiogram of the patient, or of a time/intensity curve of the contrast agent as a patient-specific parameter, represents a preferred embodiment of the method according to the invention. A blood flow analysis and a virtual representation of the blood vessel system are thereby enabled.

The adaptation of the model can take place depending on a result of the comparison. The adaptation of the model depending on an agreement of the real depiction and the virtual representation according to an agreement criterion can be repeated in an optional method step in order to obtain a more precise model and to improve the method. The agreement criterion thereby preferably provides that the virtual representation agrees to 50% to 100%—70%, 80%, 90% or 95%—with the real depiction in order to achieve more significant information about the planned procedure.

The determination of the injection profile can include a simulation of an injection of the therapeutic active substance in the model, a determination of a distribution and/or a flow pattern of the active substance. In this embodiment of the method, a more significant result (and thus a more precise conclusion about the injection to be implemented) is achieved.

The comparison can take place by a superposition and/or a difference image of respective synchronous representations, and/or the model can implement a particle simulation. A synchronization of the model and of the 2D image data set thus is achieved. For example, this can take place analytically with the aid of a time/intensity curve.

The 3D image data set and/or the 2D image data set can be provided via an x-ray device. Additionally or alternatively, an electrocardiogram and/or a heart rate of the patient can be determined as patient-specific parameters via provision of a 2D angiogram as a 2D image data set.

An image analysis device, thus a computerized electrical device or a device component that is configured to implement a method according to any of the described method embodiments, achieves the above object in the same manner.

The above object is likewise achieved by a method for therapeutic treatment of a sub-region of a vascular system of a patient, that includes providing a patient-specific injection profile according to the methods described above, and implementing a treatment of a vascular system (a TACE, for example), wherein an intravascular injection of the therapeutic active substance that is connected with this takes place using the injection profile in the sub-region of the vascular system.

The advantages already cited above are thereby enabled.

In a further embodiment of this treatment method, the treatment of the vascular system includes a trans-arterial chemo-embolization; a treatment of an arterio-venous malformation; a selective internal radiotherapy; a chemotherapy; and/or a local thrombolysis.

### BRIEF DESCRIPTION OF THE DRAWINGS

FIG. 1 a schematically illustrates an embodiment of the method according to the invention.

FIG. 2 schematically illustrates a real, two-dimensional representation, and a 3D image data set.

FIG. 3 schematically illustrates a model of a current flow, and a virtual, two-dimensional representation.

FIG. 4 schematically illustrates a real two-dimensional depiction, and a virtual real two-dimensional representation.

### DESCRIPTION OF THE PREFERRED EMBODIMENTS

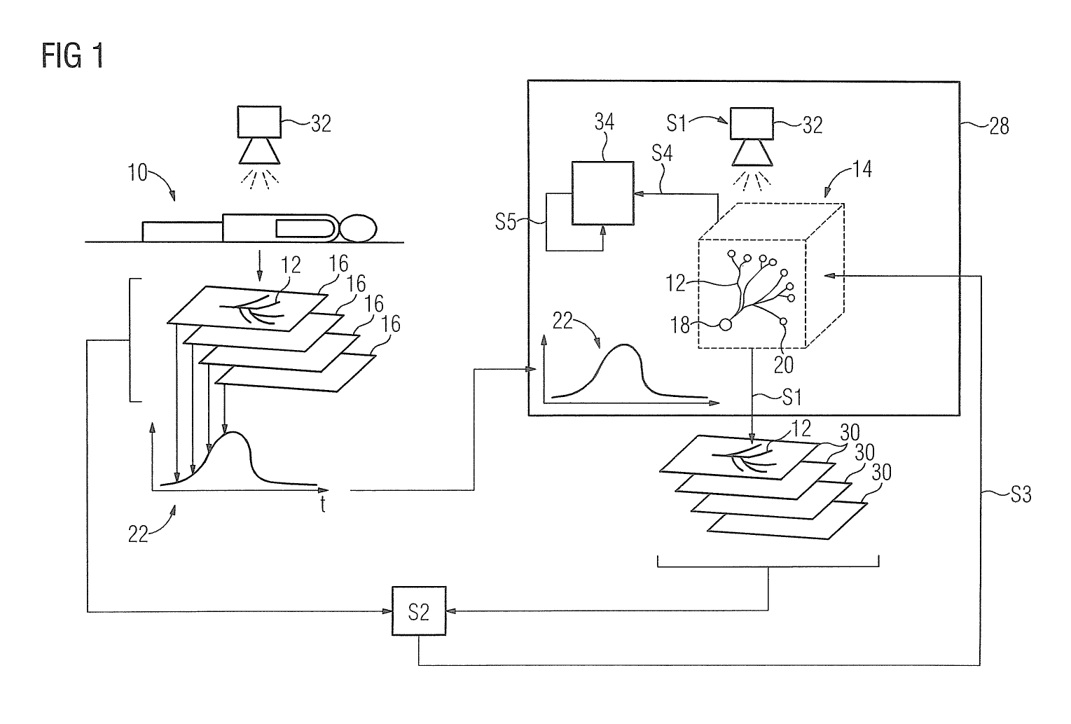

FIG. 1 illustrates the principle of the method according to the invention to determine a patient-specific injection profile that predetermines how an injection of a therapeutic active substance into a vascular system of a patient should be implemented. For example, the vascular system can comprise a blood vessel system, a lymph system or another organ forming a hollow body (a portal vein system, for example).

For example, in the present example a liver tumor has already been diagnosed in a patient 10. For example, as a treatment a treatment of the blood vessel system as a vascular system 12 of the patient 10 via a TACE (for example) is proposed, via which an active substance (for example doxorubicin as a chemo-embolizate, which should sclerotize the sub-branches of the vascular system 12 that supply the tumor) should be injected. However, the treatment should be implemented as efficiently as possible so that, for example, only a small amount of active substance is used and only a few or no other vessel branches are sclerotized in addition to the sub-branches supplying the tumor. Alternative vessel treatments that include the injection of an active substance are, for example: chemotherapy; local thrombolysis; a treatment of an arterial malformation (“AVM”); or a selective internal radiotherapy (“SIRT”).

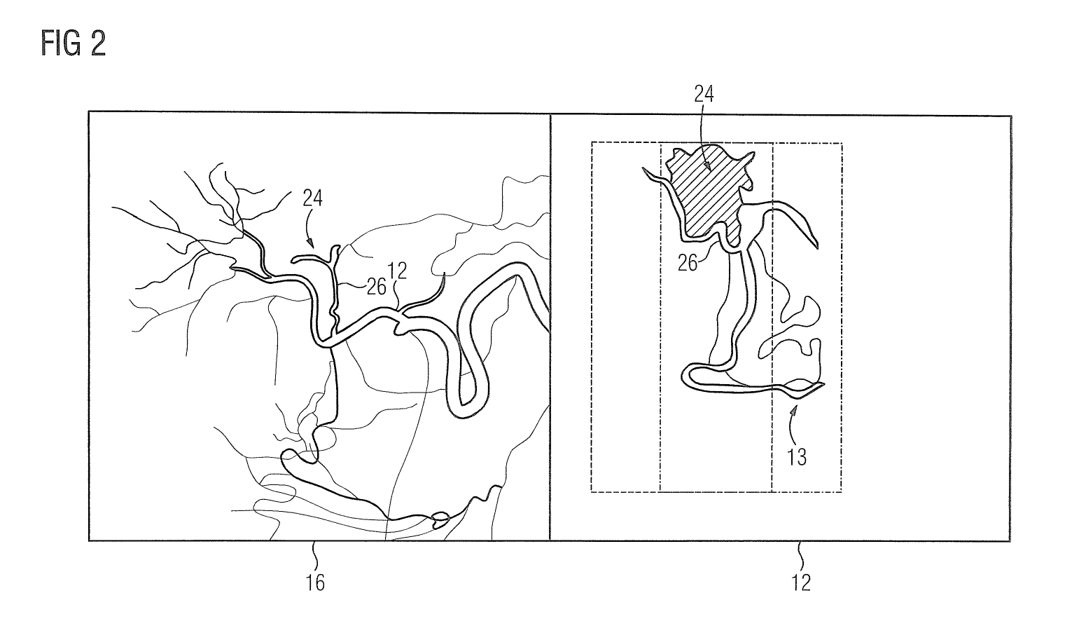

The vascular system 12 can be depicted with the use of a 3D imaging 13. FIG. 2 shows an example 3D image data set 13 of an arterial vascular system 12 that has a tumor 24 and a vessel 26 of the vascular system 12 that supplies the tumor 24. This vascular tree model is then the basis for a 3D model 14. For this, a three-dimensional (“3D”) model 14 of a current flow of the vascular system 12 and the distribution of the fluid in the individual sub-branches is initially determined. The model shows the flow of a bodily fluid flowing in the vascular system 12, thus—in the present example—includes CFD simulation of a blood flow, for example. For example, for this [sic] 3D image data set of a sub-region of the vascular system 12 can be provided via a C-arm, a DynaCT system, a DAS, a computer tomograph or a magnetic resonance angiogram (“MRA”). The model 14 can be determined by segmentation of the 3D image data, determination of at least one inflow 18 and/or at least one outflow 20 of the sub-region, and determination of an inflow curve 22 of the fluid in the sub-region. For reasons of better clarity, in FIG. 1 only some of the outflows 20 are labeled with reference characters.

The provision of at least one two-dimensional, real image data set 16 (for example at least one 2D angiogram of the vascular system 12 of the patient 10) can, for example, take place via an x-ray device 32 with a C-arm, for example. In the example of FIG. 1, four two-dimensional, real depictions 16 are provided at different points in time that show the sub-region of the vascular system 12 at four different points in time. One example of a digital subtraction angiogram as a two-dimensional, real depiction 16 is shown in FIG. 2. An image of an injected contrast agent—and therefore the movement of the contrast agent within the sub-region—can be tracked using the points in time of the acquisition. A two-dimensional, real depiction 16 can likewise be associated with a time curve of a patient-specific parameter (for example, a heart rate, a blood pressure, a heartbeat or a viscosity of the fluid) and can be synchronized with this. As an example of a patient-specific parameter, FIG. 1 shows an inflow curve 22 (over a time curve t) that, for example, is determined using a heart rate.

As an alternative to the separate provision of the 2D and 3D image data set 16, 13, the image data sets 13, 16 can also occur as a component of a combined image data set (for example by means of a four-dimensional DSA). The acquisition of the at least one patient-specific parameter—for example an electrocardiogram—can take place simultaneously with the real two-dimensional image data set 16, or independently of this.

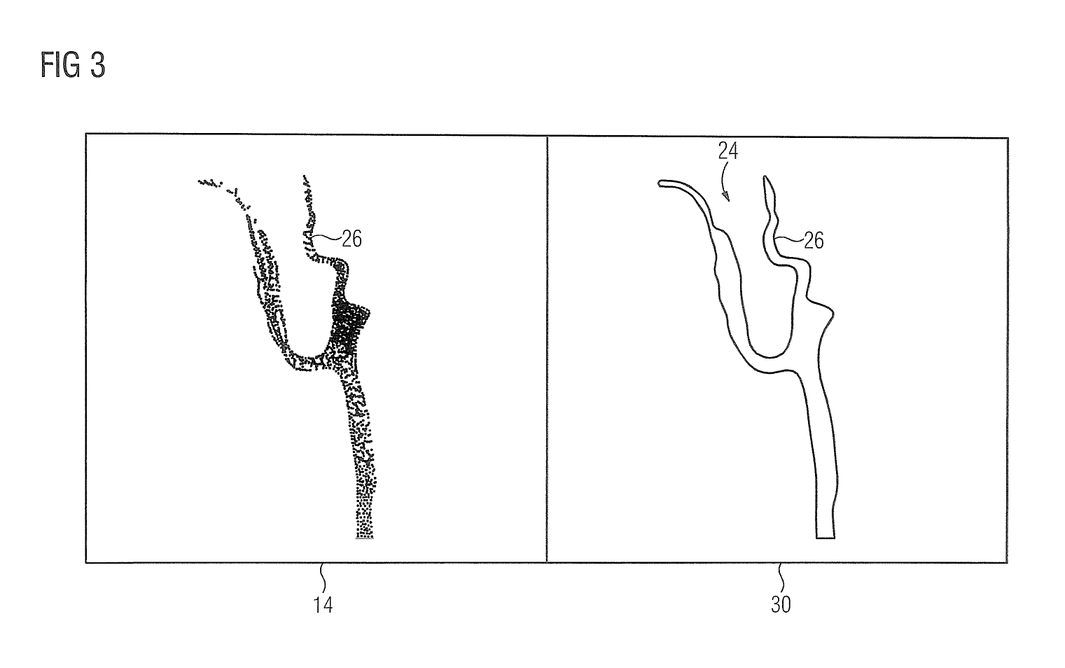

Using the model 14 (see FIG. 3), at least one virtual two-dimensional representation 30 (see FIG. 3) of the flow curve is determined that shows a virtual flow of a contrast agent (method step S1, symbolized as a virtual x-ray detector 32 in FIG. 1). For example, an image acquisition device 28 can be used for this, for example a data processing device or a microcontroller that is set up to implement an image analysis and determined a three-dimensional model. As an example, four virtual representations that depict the current flow at a respective different point in time are shown in FIG. 1.

The patient-specific parameter 22 can be used for this. Endres et al. (Jürgen Endres, Markus Kowarschik, Thomas Redei, Puneet Sharma, Viorel Mihalef, Joachim Hornegger, and Arnd Dörfler: A Workflow for Patient-Individualized Virtual Angiogram Generation Based on CFD Simulation, Computational and Mathematical Methods in Medicine Volume 2012) describe to those skilled in the art the simulation of a virtual angiography of a patient and its personalization using a CFD simulation.

In order to test the precision of the model 14, the at least one real two-dimensional depiction 16 is compared with the at least one virtual two-dimensional depiction 30 (S2). For this purpose, the inflow curve 22 and/or one or more outflow curves 22 of the fluid can be used. For example, too fast or too slow a flow in (for example) the entire vascular region 12 or in a sub-branch of the vascular system 12 can be concluded from the deviations. For example, overall too slow a flow can be corrected (and therefore individualized) by, for example, an adaptation of the inflow 18 in the model 14. Differences in the individual outflow vessel segments 20 can be individualized via an adaptation of the boundary condition, for example the change of a pressure at the outflow 20. The real 2D image data set consequently has the function of a reference data set. For example, a simple method for adaptation is to vary the pressure at the outflow boundary conditions until the correct flow velocity is achieved in each sub-branch. For example, this corresponds to the consideration of the individual vessel resistance in the different sub-branches (for example due to different lengths, previous treatments or tumor vascularization).

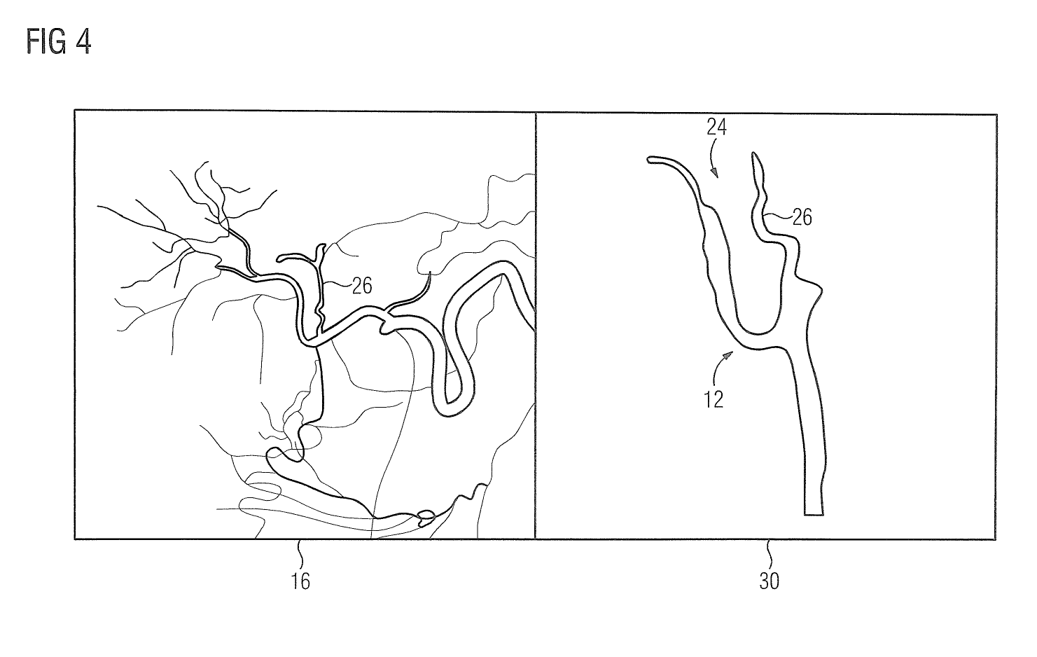

The comparison of the cited image data sets 16, 30 (S2) can thereby take place by means of, for example, a superposition of the image data sets 16, 30 and/or the determination of a difference image via determination of the sum of the squared differences. For this purpose, a real depiction 16 and the virtual representation 30 are contrasted again in FIG. 4 for illustration. Alternatively or additionally, a particle simulation can be implemented using the model 14. An inflow 18 of each image data set can be superimposed as an example, and then the at least one outflow 20 can be adapted. For example, according to the respective depiction it can then be determined at which point in time a contrast agent is located at which point in the vascular system 12. If the points in time deviate in real and virtual representation 16, 30, the model 14 can be adapted.

The comparison of the image data sets 16, 30 (S2) and/or the adaptation of the model 14 (S3) can be repeated depending on an agreement criterion. For example, the agreement criterion can predetermine that an agreement of 50% to 100% (70%, 80% or 90% agreement) of the virtual and real image data set 16, 30 exists. The adaptation of the model 14 can take place via modification of boundary conditions, for example by changing a force with which the fluid flows in the vascular system 12 and/or via consideration of a patient-specific parameter 22, for example blood properties of the patient 10 whose blood is under the influence of a blood-thinning medicine, for example.

If the model 14 has a predetermined precision, the determination of the injection profile 34 (S4) takes place via determination of at least one parameter that pertains to the implementation of the planned injection using the personalized model 14. Simulation of an injection of the active substance can be represented in the model 14, which includes a determination of a distribution and/or a flow pattern of the active substance.

The determination of the at least one parameter that concerns the planned injection can include the determination of: an injection point in time; an amount of active substance; and/or an injection location in the sub-region.

Using the real and virtual depiction 16, 30, for example, an advantageous injection point in time can consequently be determined using the model 14 so that the active substance is specifically conducted into the supplying vessel branch 26 during a later treatment and so that the amount of active substance that flows into other sub-branches is reduced.

The exemplary embodiment described above illustrates the principle of the invention to optimize a three-dimensional image data set 13 of a vascular system 12 of a patient 10—for example a CFD (Computational Fluid Dynamics) simulation of a blood flow—using a two-dimensional image data set 16, for example a digital subtraction angiography (“2D-DSA”), and to personalize said optimization for use in a patient 10. For example, information can thus be obtained for an ideal therapy planning, for example for a TACE. In addition to this, the approach offers the possibility to compare the planning results with the real conditions based on the three-dimensional image data set.

The vascular system 12—for example an arterial vascular tree—can be depicted with the aid of a 3D imaging 13 (for example DynaCT). This vascular tree model is then the basis of for example, a CFD simulation of the blood flow and the distribution in the individual sub-branches. The parameters and the patient-specific conditions for the simulation cannot be standardized, but rather must be optimized for individual patients 10.

The invention encompasses the idea to patient-specifically optimize the calculation of a current flow of the fluid of the vascular system 12 (a blood flow, for example)—which calculation is used for planning an embolization, for example—and based on this to simulate one or more virtual injections of a treatment (an embolization, for example). Their results then form the basis of an improved therapy planning, for example.

An additional exemplary embodiment of an example method workflow includes the following steps:

1. 3D imaging 13 of, for example, vessels 26 supplying a tumor 24 or, respectively, of the entire relevant vascular tree 12 (for example CT, MRA, C-arm DSA).

2. 2D angiography 16 (for example via a C-arm) of a vessel 26 supplying the tumor 24, or of the entire relevant vascular tree 12.

3. Determination of, for example, a heart rate of the patient 10 as a patient-specific parameter 22, for example during an 2D angiography.

As an alternative to the separate 3D and 2D acquisitions 16, 30, for example, a combined acquisition can also take place that allows the simultaneous acquisition of all necessary parameters (for example 4D DSA with EKG acquisition).

4. Determination of a model 14 of a current flow (for example a CFD simulation of the blood flow) in a defined sub-region of the vascular tree 12 with initial inflow curve 22 with above patient-specific parameters; this can include the following steps: create a 3D geometry of the vascular tree 12 by means of segmentation of the 3D data from point 1); determine at least one inflow 18 and, for example, multiple outflows 20 of the vascular segment 12; and define the boundary conditions for the example CFD simulation (for example viscosity, density of blood, inflow curve).

5. Calculation of a patient-specific, synchronized, virtual two-dimensional depiction—for example a patient-specific, synchronized, virtual angiogram 30—based on the example CFD simulation (see also Endres et al., 2012). For example, the time curve of a contrast agent injection is initially extracted from the real 2D depiction 16 from 2) and synchronized with the heart beat 22, for example. With the use of a velocity information, the virtual 2D depiction 30 can subsequently be calculated from the model 14 and the determined contrast agent injection.

6. Individualize the example inflow curve 22 and the individual outflows 20 via the comparison of the real and virtual two-dimensional depictions 16, 30. The adaptation of the model 15 can be implemented as was already described in the above exemplary embodiment.

7. Repeat steps 4) and 5) until a sufficiently good agreement is achieved between the virtual and real depiction 16, 30.

8. Virtual injection of the active substance (an embolizate, for example) and calculation of an injection location (thus an injection site), a distribution and/or of a flow pattern of the active substance distribution, for example. For example, the distribution of the active substance can be calculated after the simulation has been sufficiently individualized. For this, the special properties of the active substance (for example density and viscosity) can also be considered, and the injection profile is established—for example including a parameter with regard to an injection site (thus an injection location)—in the event that an absolute distribution should be calculated. The subsequent injection of the active substance should take place with the injection profile and velocity as it has also been established in the simulation.

For example, a possibility of validating the model 14 results from this with the aid of, for example, the real 2D image data set and the virtual depiction 30 for better therapy planning and estimation of success.

The TACE application is noted only as an example. Furthermore, all applications are conceivable in which a vascular system 12 (blood vessels, for example) are affected in an interventional manner and a simulation is helpful, for example given arterio-venous malformation (thus given an AVM treatment). The procedure is also usable for other applications, for example for uterine fibroids. In addition to this, the possibility is offered to plan the distribution not only of an embolizate but rather, for example, of intravascular injections of therapeutics or medicines, for example selective internal radiotherapy (SIRT or also radio-embolization).

Although modifications and changes may be suggested by those skilled in the art, it is the intention of the inventors to embody within the patent warranted hereon all changes and modifications as reasonably and properly come within the scope of their contribution to the art.

We claim as our invention:

1. A method to determine a patient-specific injection profile that predetermines administration of a therapeutic substance to a patient by injection of the therapeutic substance into a vascular system of the patient, comprising:
in a computer, automatically determining a model of a current flow of a bodily fluid in a sub-region of said vascular system, using a 3D image data set provided to the computer, by segmenting said sub-region from said 3D image data set, and automatically determining at least one of at least one inflow into and at least one outflow from said sub-region, and from said at least one inflow or said at least one outflow, automatically determining an inflow curve of said fluid in said sub-region;
in said computer, automatically determining a virtual 2D representation of a current flow a contrast agent injected into said sub-region;
in said computer, comparing a 2D image data set provided to said computer, as a real 2D representation of said sub-region, with said virtual representation and, based on said comparison, adapting said model to individualize said model to make said model specific to said patient; and
in said computer, automatically determining said injection profile by determining at least one parameter of said injection using said individualized model, and making said injection profile available as an electronic signal at an output of said computer.

2. A method as claimed in claim 1 comprising, in said computer, optimizing said injection profile according to an optimization criterion.

3. A method as claimed in claim 1 wherein said parameter is a point in time of said injection, and comprising optimizing said injection profile by modifying said point in time of said injection according to an optimization criterion.

4. A method as claimed in claim 1 comprising determining said virtual 2D representation of the current flow by extracting a time curve of said contrast agent injected into said sub-region from the provided 2D image data set, and synchronization of the extracted time curve with a patient-specific parameter, or transferring said time curve to said to model of said current flow.

5. A method as claimed in claim 1 comprising determining said virtual 2D representation from an electrocardiogram of the patient provided to said computer, or a time-intensity curve of said contrast agent as a patient-specific parameter.

6. A method as claimed in claim 1 comprising adapting said model repeatedly dependent on repeating comparisons of said real depiction and said virtual representation, dependent on a comparison agreement criterion.

7. A method as claimed in claim 6 comprising employing, as said comparison agreement criterion, a criterion that requires a predetermined percentage of agreement between said virtual representation and said real depiction.

8. A method as claimed in claim 1 comprising determining said injection profile to include at least one of a simulation of injection of the therapeutic active substance in the model, determination of a distribution of the therapeutic active substance in the model, and a flow pattern of the active substance in the model.

9. A method as claimed in claim 1 comprising determining said at least one parameter for said planned injection as a parameter selected from the group consisting of a point in time of said injection, and amount of said active substance, and a location in said sub-region of said injection.

10. A method as claimed in claim 9 comprising providing at least one of said 3D image data set to said computer from an x-ray imaging apparatus.

11. A method as claimed in claim 10 comprising determining an electrocardiogram or a heart rate of the patient as a patient-specific parameter using a 2D angiogram as said 2D image data set.

12. A method as claimed in claim 1 comprising implementing said comparison in said computer by a superimposition of respective synchronous depictions.

13. A method as claimed in claim 1 comprising implementing said comparison in said computer by a difference of respective synchronous depictions.

14. A method as claimed in claim 1 comprising implementing said comparison as a particle simulation.

15. A method to determine a patient-specific injection profile that predetermines administration of a therapeutic substance to a patient by injection of the therapeutic substance into a vascular system of the patient, comprising:
in a computer, automatically determining a model of a current flow of a bodily fluid in a sub-region of said vascular system, using a 3D image data set provided to the computer, by segmenting said sub-region from said 3D image data set, and automatically determining at least one of at least one inflow into and at least one outflow from said sub-region, and from said at least one inflow or said at least one outflow, automatically determining an inflow curve of said fluid in said sub-region;
in said computer, automatically determining a virtual 2D representation of a current flow a contrast agent injected into said sub-region;
in said computer, comparing a 2D image data set provided to said computer, as a real 2D representation of said sub-region, with said virtual representation and, based on said comparison, adapting said model to individualize said model to make said model specific to said patient;
in said computer, automatically determining said injection profile by determining at least one parameter of said injection using said individualized model, and making said injection profile available as an electronic signal at an output of said computer; and
implementing treatment of said vascular system by an intravascular injection of said therapeutic active substance using said injection profile.

16. A method as claimed in claim 15 comprising implementing said treatment of the vascular system selected from the group consisting of a transmission-arterial chemo-embolization, treatment of an arterial-venous malformation, selective internal radiotherapy, chemotherapy, and a local thrombolysis.

17. An image analysis device to determine a patient-specific injection profile that predetermines administration of a therapeutic substance to a patient by injection of the therapeutic substance into a vascular system of the patient, comprising:
a computer configured to automatically determine a model of a current flow of a bodily fluid in a sub-region of said vascular system, using a 3D image data set provided to the computer, by segmenting said sub-region from said 3D image data set, and automatically determining at least one of at least one inflow into and at least one outflow from said sub-region, and from said at least one inflow or said at least one outflow, automatically determining an inflow curve of said fluid in said sub-region;
said computer being configured to automatically determine a virtual 2D representation of a current flow a contrast agent injected into said sub-region;
said computer being configured to compare a 2D image data set provided to said computer, as a real 2D representation of said sub-region, with said virtual representation and, based on said comparison, adapting said model to individualize said model to make said model specific to said patient; and
said computer being configured to automatically determine said injection profile by determining at least one parameter of said injection using said individualized model, and to make said injection profile available as an electronic signal at an output of said computer.
